(19) United States
(12) Patent Application Publication
(10) Pub. No.: US 2003/0230684 A1
(43) Pub. Date: Dec. 18, 2003

(54) Fishing post

(76) Inventor: John Edward Clary, Ames, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/171,105

(22) Filed: Jun. 13, 2002

(51) Int. Cl. F21V 21/00

(52) U.S. Cl. 248/219.2; 248/309.1

(57) ABSTRACT

A removable post cap for attachment on top of dock posts. It has a carrying handle and fits over the dock post. Attached to the cap are a plurality of post cap accessories, such as cup holders, mini-tackle box, a fishing pole holder and gear hooks.

### FIELD OF THE INVENTION

This invention relates to a removable post cap for attachment atop one of the dock support posts of docks or piers, commonly used to extend access from the shore out into a lake, ocean harbor, etc.

### BACKGROUND OF THE INVENTION

This invention relates to a device, based upon a removable post cap particularly adapted for attachment to exterior end posts of docks, commonly associated with fresh water lakes. It is understood, however, that it could also be used for piers that extend into the ocean.

Docks or piers allowing access beyond just the shoreline of fresh water lakes or to the ocean are common. The invention will be described hereafter particularly with respect to fresh water lake docks, but it is understood that it could be used with piers as well.

Commonly along fresh water lakes, the shoreline property owners use docks. The dock provides accessibility to a boat hoist, the lakeshore owner's boat, and provides a seating area to enjoy sitting, surrounded by water for fishing or relaxation.

One of the reasons the end of such docks are used for fishing is because the area under the docks and the shadows caused by the dock usually provide an area around which fish congregate. When one is engaged in such fishing activity, one's tackle box, lures and leaders are all at risk as they sit on the end of the dock. It is not uncommon to spill those over into the water, losing them.

Moreover, the top end of dock posts are often susceptible to environmental damage caused by extreme heat, sun, rain, moisture, humidity, etc. As a result, dock posts, particularly if they are of wood, commonly rot. If they are metal tubes, it is not uncommon to lose things, falling down into the interior shaft of the dock post.

It therefore can be seen that a need exists for some sort of a system to be placed on top of dock posts which allow safekeeping of fishing gear, lures, etc. and which provides an environmentally safe protective cover on top of the dock post. This invention has as its primary objective the fulfillment of this need.

### BRIEF SUMMARY OF THE INVENTION

With respect to the preferred embodiment, the invention provides a removable post cap which can be positioned on top of an end dock post. The post cap has a handle, is easily removable from the post, and as well has attached to the post cap a plurality of post cap accessories. Acceptable and usable accessories include, but are not limited to, cup/can holders, a mini-tackle box, fishing pole holders and gear hooks.

### BRIEF DESCRIPTION OF THE DRAWINGS

FIG. 1A is a dock holder in perspective view mounted on an end post with attached gear hooks.

FIG. 1B shows a similar post cap without gear hooks.

FIG. 2 shows a similar post cap with a single gear hook attached on top of the mini-tackle box.

FIG. 3 shows a plan view of the fishing post cap of FIG. 1.

FIG. 4 shows a cross-sectional view along line 4-4 of FIG. 3.

FIG. 5 shows the end of the dock, including the dock platform with the support post of FIG. 1B attached thereto.

FIG. 6 shows a perspective view of the dock post of FIG. 2 with the mini-tackle box door closed.

FIG. 7 shows the dock post cap of FIG. 1B with the mini-tackle box door closed.

FIG. 8 shows a side view opposite the perspective view of FIG. 7 of the dock post of FIG. 1B.

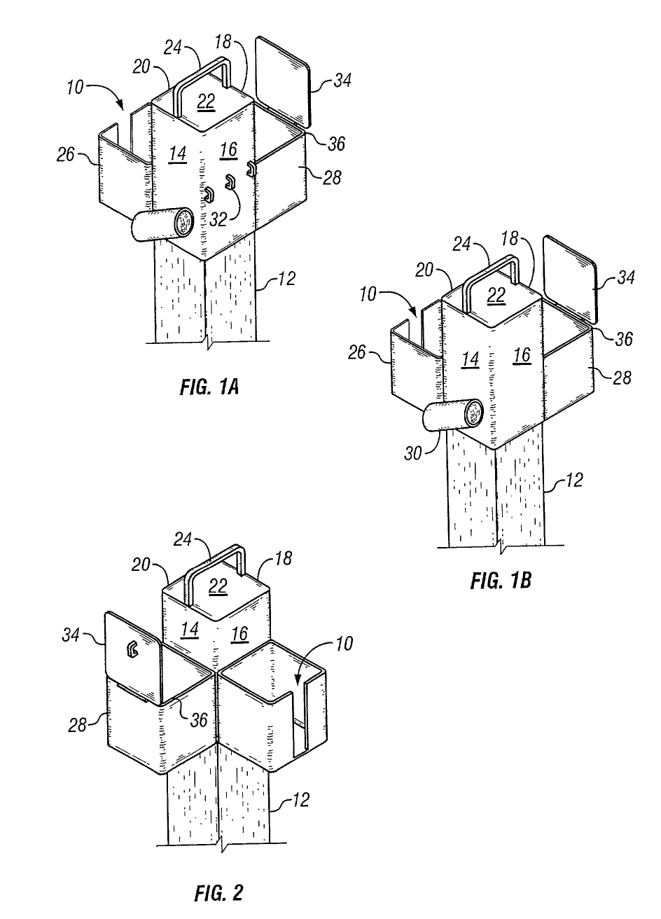

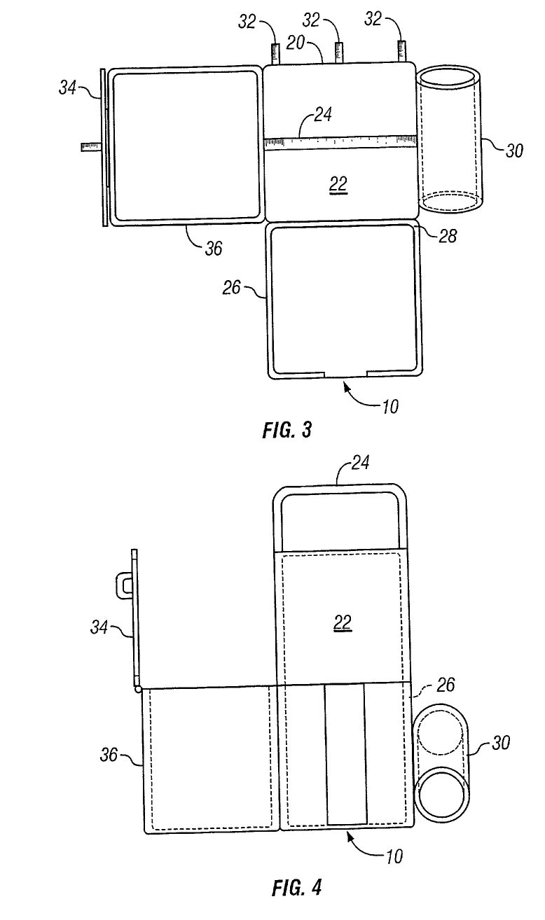

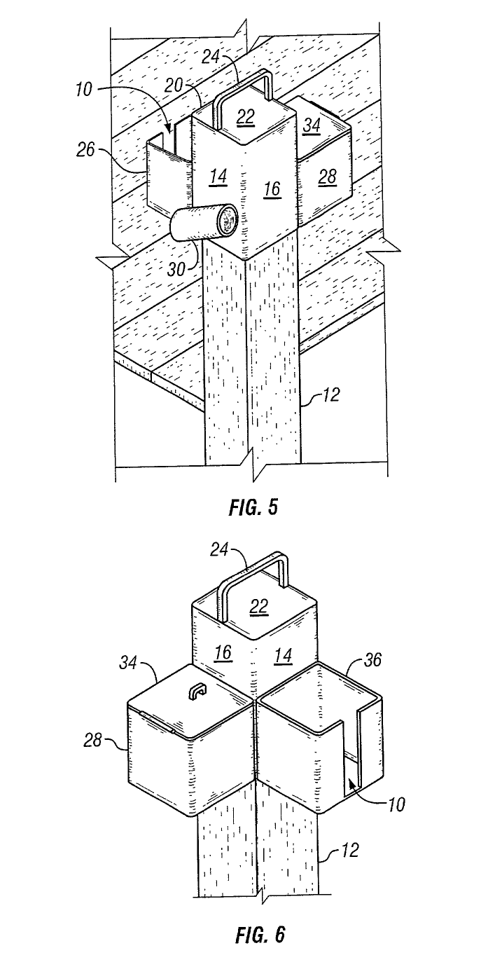

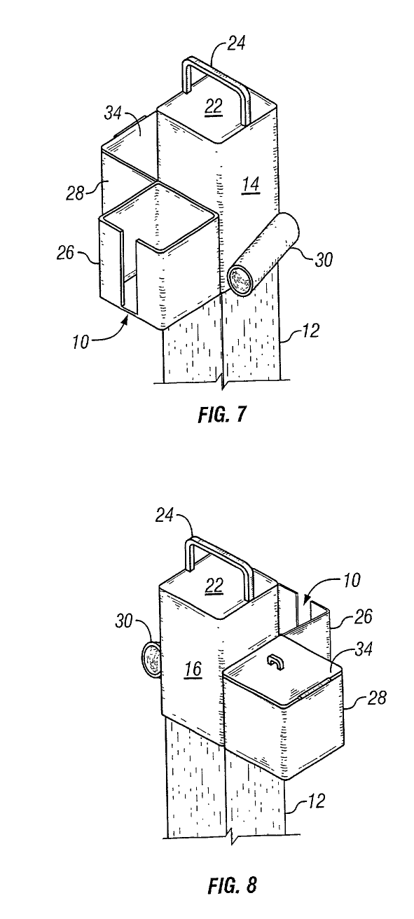

### DETAILED DESCRIPTION OF THE PREFERRED EMBODIMENT

This invention relates to an integral dock post cap referred to generally as 10 for fitting over the top end of dock post 12.

Referring now to the protective cap, it comprises four sides 14, 16, 18 and 20 and a cap top 22, all joined to form a cap which can fit over dock post 12. Attached to the post cap top 22 is handle 24. It can therefore be seen that cap 12 can be inserted over the top of post 10 and provides an environmental-proof top over the end of post 12. Moreover, it is not attached at all and can be easily removed simply by lifting on handle 24, and sliding the cap and all of the attached accessories off the post thus making it an easy carrier for the contents of the cap accessories.

Attached to the various sides 14, 16, 18 and 20 of post cap 10 are a variety of post cap accessories. The accessories can vary as much as the imagination of the fisherman/lakeshore owner desires. They can include, however, a cup/can holder 26, a mini-tackle box 28, a fishing pole holder 30, and gear hooks 32. Mini-tackle box 28 has a lid 34 that is hingedly attached at 36 to tackle box 28. It goes without saying that other accessories could be provided in lieu or in addition to those mentioned. For example, a holder for a minnow bucket could be attached. A mini ice chest could be attached, a mini first aid kit holder could be attached, a mini radio holder could be attached, etc.

The post cap can be made from metals such as steel and/or aluminum, or it can be plastic. If plastic, injection molded units of unitary configuration work well.

From above it can be seen that the invention accomplishes all of its stated objectives.

What is claimed is:

1. A removable dock post cap for fitting over the top end of a dock post comprising:
a removable post cap;
a carrying handle on said removable post cap; and
a plurality of post cap accessories mounted to said post cap.

2. The removable post cap of claim 1 wherein the plurality of post cap accessories are selected from the group consisting of cup/can holders, mini-tackle box, fishing pole holder, gear hooks, a mini minnow box, and a mini first aid kit.

3. The removable post cap of claim 2 wherein the plurality of accessories include a cup holder, a mini-tackle box, and a fishing pole holder.

4. The removable post cap of claim 1 wherein the post cap and the accessories are all made of metal.

5. The removable post cap of claim 1 wherein the post cap and the plurality of accessories are all made of steel.

6. The removable post cap of claim 4 wherein the device is all made of aluminum.

7. The removable post cap of claim 1 wherein the entire device is made of plastic.

8. The device of claim 7 wherein the plastic post cap is all made from a unitary plastic mold suitable for injection molding of a plastic removable cap.
